(19) United States
(12) Patent Application Publication
(10) Pub. No.: US 2004/0251085 A1
(43) Pub. Date: Dec. 16, 2004

(54) Mast assembly for forklift truck and method of manufacturing the same

(76) Inventor: Yasushi Kuwano, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 10/859,812

(22) Filed: Jun. 3, 2004

(30) Foreign Application Priority Data
Jun. 4, 2003 (JP) 2003-159821

(51) Int. Cl. B66F 9/06

(52) U.S. Cl. 187/226; 187/230

(57) ABSTRACT

A mast assembly for a forklift truck includes an outer mast, an inner mast and a lift bracket. The outer mast includes a pair of substantially vertical outer mast rails and a substantially horizontal first outer mast beam. The first outer mast beam is connected to the outer mast rails by means of bolt connection. The inner mast vertically movably connected to the outer mast via mast rollers and includes a pair of substantially vertical inner mast rails and a substantially horizontal inner mast beam. The inner mast beam is connected to the inner mast rails by means of bolt connection. The lift bracket is connected to the inner mast via lift rollers.

### BACKGROUND OF THE INVENTION

The present invention relates to a mast assembly in a forklift truck and a method of manufacturing the mast assembly of the forklift truck.

A mast assembly used in a forklift truck generally includes an outer mast which is connected to the truck body and an inner mast which is located inside and vertically movable along the outer mast. A lift bracket is connected to the inner mast in such a way that it is vertically movable along the inner mast. According to a conventional method of manufacturing such mast assembly, the outer mast, the inner mast and the lift bracket are respectively formed by welding parts such as rails and beams and these welded component parts are assembled to form the mast assembly. Japanese Unexamined Patent Publication No. 11-171489 discloses a mast assembly having a carriage holding structure. Further, Japanese Unexamined Patent Publication No. 6-1598 discloses another type mast assembly.

To manufacture the mast assemblies disclosed in the above references, the outer mast, the inner mast and the lift bracket are assembled to each other after they have been individually formed. In this case, since the outer mast, the inner mast and the lift bracket are relatively large in size, a large-size jig or fixture is needed, accordingly. Therefore, it has been a time-consuming operation to manufacture a mast assembly. Additionally, since the outer mast, the inner mast and the lift bracket are formed by welding according to the prior art, it is difficult to accomplish the desired dimensional accuracy after the mast assembly has been assembled and, therefore, there has been a need to eliminate looseness between parts in the width direction of the mast assembly. For the purpose of such adjustment, shims are interposed between a roller and a roller pin, and the parts need to be temporarily assembled for this adjustment. Thus, the above adjustment involves troublesome and time-consuming operation.

Furthermore, in parts control or management for the mast assembly, the parts of the outer masts, the inner masts and the lift brackets need to be classified into separate groups. For a mast assembly having a different width dimension, for example, the parts therefor have part numbers different from those of parts for different mast assembly. Therefore, the number of part reference numbers tends to be increased, and it takes more time and labor for controlling or management of the parts.

### SUMMARY OF THE INVENTION

The present invention provides a mast assembly of a forklift truck and a method of manufacturing the mast assembly, according to which it is easy to eliminate looseness between parts in the width direction of the mast assembly. The invention also provides a mast assembly which is easy to manufacture and makes mast assembly parts management easier.

According to the present invention, a mast assembly for a forklift truck includes an outer mast, an inner mast and a lift bracket. The outer mast includes a pair of substantially vertical outer mast rails and a substantially horizontal first outer mast beam. The first outer mast beam is connected to the outer mast rails by means of bolt connection. The inner mast vertically movably connected to the outer mast via mast rollers and includes a pair of substantially vertical inner mast rails and a substantially horizontal inner mast beam. The inner mast beam is connected to the inner mast rails by means of bolt connection. The lift bracket is connected to the inner mast via lift rollers.

The present invention also provides a method of manufacturing a mast assembly for a forklift truck. The mast assembly includes a lift bracket, an inner mast and an outer mast. The lift bracket has lift rollers. The inner mast has a pair of substantially vertical inner mast rails and a substantially horizontal inner mast beam, and the outer mast has a pair of substantially vertical outer mast rails and a substantially horizontal outer mast beam. The method includes the steps of placing respectively a pair of the inner mast rails on both outsides of the lift bracket via the lift rollers; connecting the inner mast beam to each of the inner mast rails by means of bolt connection so as to form the inner mast; placing respectively a pair of the outer mast rails on outsides of the inner mast rails via mast rollers; and connecting the outer mast beam to each of the outer mast rails by means of bolt connection so as to form the outer mast.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a schematic side view of the forklift truck according to a first preferred embodiment;

FIG. 2 is a rear view of a mast assembly of the forklift truck according to the first preferred embodiment;

FIG. 3 is a rear view of a lift bracket of the mast assembly according to the first preferred embodiment;

FIG. 4 is a rear view of an inner mast of the mast assembly according to the first preferred embodiment;

FIG. 5 is an exploded top view of X portion of FIG. 4;

FIG. 6 is a rear view of an outer mast of the mast assembly according to the first preferred embodiment;

FIG. 7 is an exploded top view of Y portion of FIG. 6;

FIG. 8 is an exploded top view of Z portion of FIG. 6;

FIG. 9 is a exploded top view illustrating a process of assembling the mast assembly according to the first preferred embodiment; and

FIG. 10 is a top plan view of a connection between the outer mast rail and the outer mast beam of the outer mast in the mast assembly according to a second preferred embodiment.

### DETAILED DESCRIPTION OF THE PREFERRED EMBODIMENTS

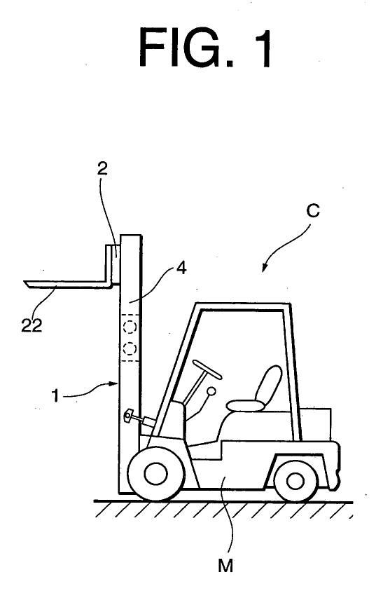

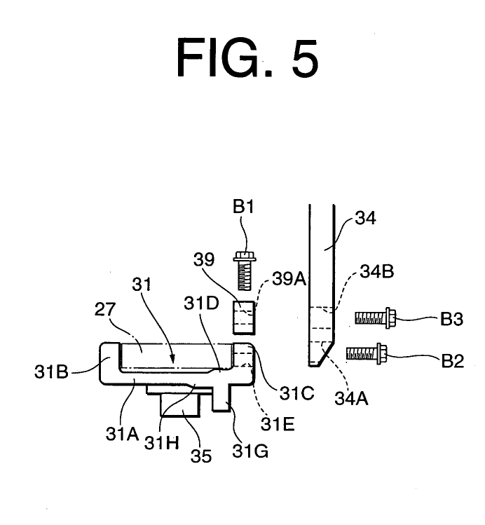

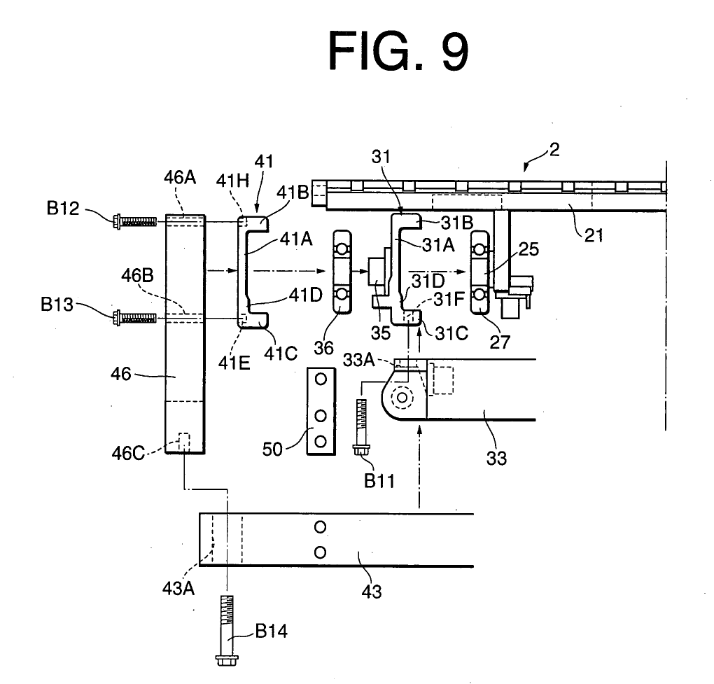

The following will describe preferred embodiments of the present invention with reference to FIGS. 1 through 10. It is noted that, in FIGS. 5, 7 and 8, the left and right sides on the drawing correspond to the front and rear sides of the mast assembly, respectively, and the upper and lower sides correspond to the right and left sides of the mast assembly, respectively. In FIG. 9, the upper and lower sides correspond to the front and rear sides of the mast assembly, respectively.

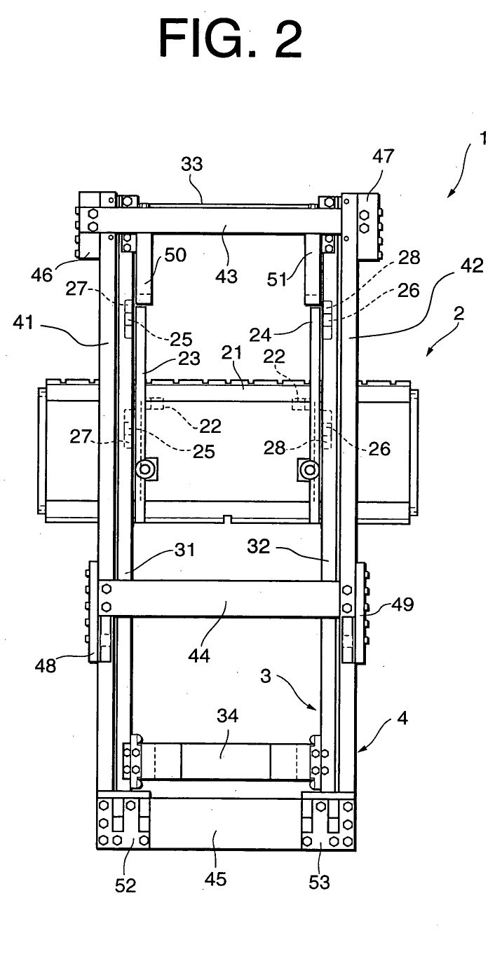

Referring to FIG. 1, a forklift truck C according to the first preferred embodiment includes a truck body M and a mast assembly 1 connected to the body M. The mast assembly 1 includes a lift bracket 2, an inner mast 3 (shown in FIG. 2), an outer mast 4 and a fork 22. As shown in FIG. 2, the mast assembly 1 is constructed substantially symmetrically.

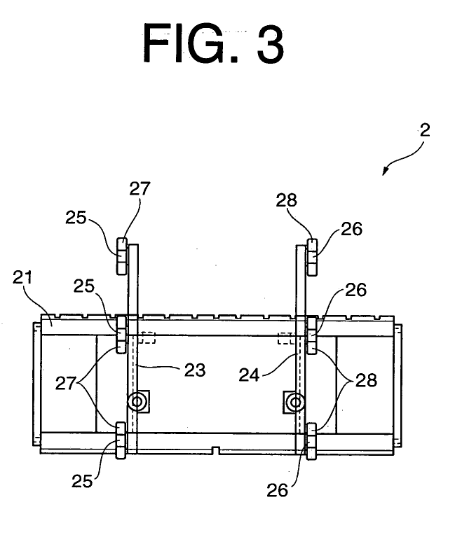

Referring to FIG. 3, the lift bracket 2 has a backrest 21, to which a finger bar (not shown) is connected. The fork 22 is connected to the finger bar. A pair of vertical bars 23, 24 is connected to the backrest 21 and roller pins 25, 26 are connected to the vertical bars 23, 24, respectively. Lift rollers 27, 28 are press-fitted onto the roller pins 25, 26, respectively, for rotation on the roller pins 25, 26.

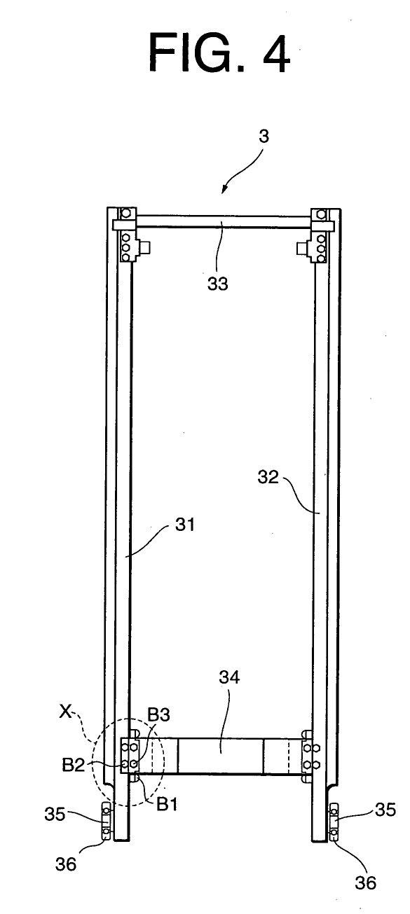

Referring to FIG. 4, the inner mast 3 includes a pair of substantially vertical inner mast rails 31, 32. As shown in FIG. 2, the lift rollers 27, 28 of the lift bracket 2 are located inside the inner mast rails 31, 32, respectively, to roll along the inner mast rails 31, 32. As the lift rollers 27, 28 thus move rolling, the lift bracket 2 vertically moves relative to the inner mast 3. The paired inner mast rails 31, 32 are connected to each other at the top thereof by a substantially horizontal inner mast top beam 33 and at the opposite bottom thereof by a substantially horizontal inner mast bottom beam 34. A pair of roller pins 35 protrudes outward from the lower portions of the inner mast rails 31, 32, respectively. A lower mast roller 36 is press-fitted onto each of the roller pins 35 for rotation on the roller pin 35. The inner mast rails 31 and 32 are fixed to the inner mast top beam 33 and the inner mast bottom beam 34 by means of bolts.

Referring to FIG. 5, the left-side inner mast rail 31 as seen from the rear of the truck C includes a side frame 31A having formed on the front thereof a front flange 31B and on the rear thereof a rear flange 31C so that the side frame 31A is U-shaped in its cross section. A shoulder 31D is formed on the rear portion of the side frame 31A adjacent to the rear flange 31C. A seat 39 is provided at the top end of the rear flange 31C. Bolt holes 31E and 39A are formed through the rear flange 31C and the seat 39, respectively, along the longitudinal direction of the truck. Although not shown, another bolt hole is formed vertically extending through the seat 39 and reaching the inside of the rear flange 31C. A bolt B1 is screwed into the bolt hole in the seat 39 and the rear flange 31C so that the seat 39 is fixed to the rear flange 31C. With reference to FIG. 9, a bolt hole 31F is similarly formed in the top portion of the inner mast rail 31. Furthermore, an outer flange 31G is formed on the side flame 31A at the side opposite to the rear flange 31C. An outer shoulder 31H is formed on the side flame 31A at the front side of the outer flange 31G. A second bolt connection portion of the present invention corresponds to the top end of the rear flange 31C.

Still referring to FIG. 5, elongated holes 34A, 34B are formed extending through the inner mast bottom beam 34 along the longitudinal direction of the truck and function as an inner mast rail width adjusting means of the present invention for adjusting the width between the inner mast rails 31, 32. The elongated holes 34A, 34B are formed such that the lateral dimension thereof is larger than the vertical dimension which is substantially the same as the diameter of the bolt holes 31E, 39A. Bolts B2, B3 are screwed through the elongated holes 34A, 34B and then into the bolt holes 31E and 39A that are formed in the rear flange 31C of the inner mast rail 31 and the seat 39, respectively. The bolt connection between the inner mast rail 31 and the inner mast bottom beam 34 includes the bolts B2, B3, the elongated holes 34A, 34B and the bolt holes 31E, 39A. The inner mast bottom beam 34 is connected to the inner mast rail 31 by means of the above bolt connection. Furthermore, the inner mast bottom beam 34 is connected to the inner mast rail 32 by means of bolt connection similar to the above bolt connection, and the inner mast top beam 33 is connected to the inner mast rails 31, 32 also by means of the similar bolt connection. The second bolt connection portion also corresponds to the portion of the inner mast bottom beam 34 through which the elongated holes 34A, 34B extend.

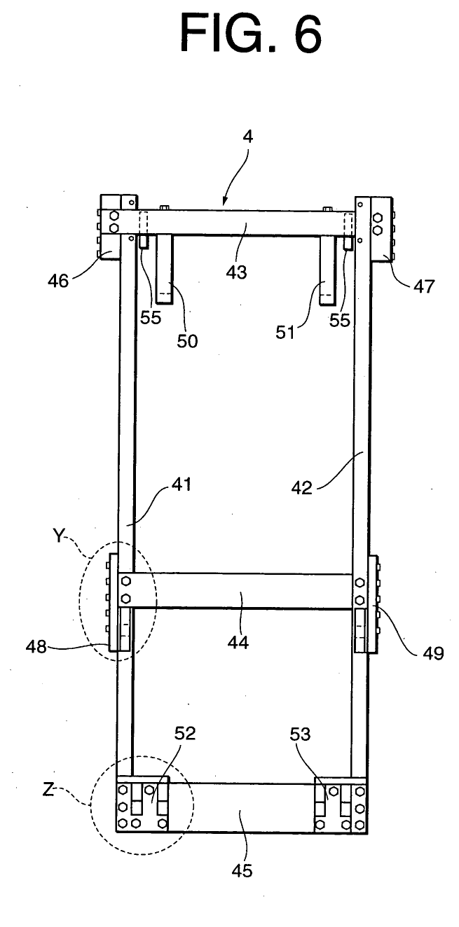

Referring to FIG. 6, the outer mast 4 includes a pair of substantially vertical outer mast rails 41, 42. As shown in FIG. 2, the inner mast rails 31 and 32 are located inside the outer mast rails 41 and 42. Although not shown in FIG. 2, the lower mast rollers 36 connected to the inner mast rails 41 and 42 are located inside the outer mast rails 41 and 42 so as to move rolling along the outer mast rails 41 and 42. As the lower mast rollers 36 thus roll, the inner mast 3 vertically moves relative to the outer mast 4. The paired outer mast rails 41 and 42 are connected to each other at the top thereof by a substantially horizontal outer mast top beam 43, at a middle by a substantially horizontal outer mast middle beam 44, and at the bottom by a substantially horizontal outer mast bottom beam 45. The outer mast rails 41 and 42 are connected to the outer mast top beam 43 by outer mast top beam brackets 46 and 47, respectively. Similarly, the outer mast rails 41 and 42 are connected to the outer mast middle beam 44 by outer mast middle beam brackets 48 and 49, respectively. Furthermore, the outer mast rails 41 and 42 are directly connected to the outer mast bottom beam 45. Meanwhile, chain anchor plates 50 and 51 are connected to the outer mast top beam 43, and chain anchor plates 52 and 53 are connected to the outer mast bottom beam 45. A first outer mast beam of the present invention corresponds to the outer mast top beam 43 and the outer mast middle beam 44, and a second outer mast beam of the present invention corresponds to the outer mast bottom beam 45.

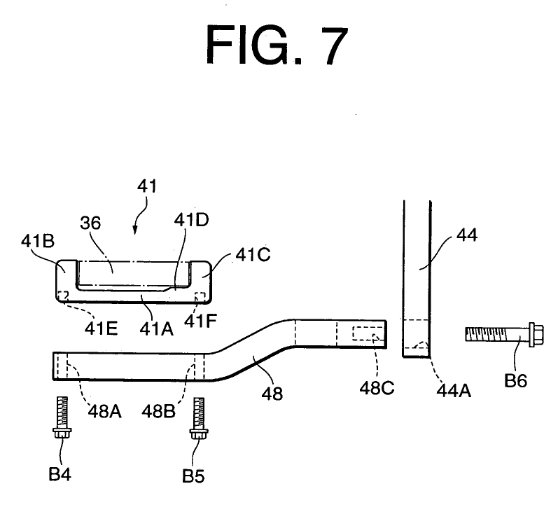

Referring to FIG. 7, the outer mast rail 41 includes a side flame 41A having formed on the front thereof a front flange 41B and on the rear thereof a rear flange 41C so that the side frame 31A is U-shaped in its cross section. Also, a shoulder 41D is formed on the rear side of the side flame 41A adjacent to the rear flange 41C. The aforementioned outer mast middle beam bracket 48 is placed on the outer side of the outer mast rail 41. Bolt holes 48A and 48B are formed so as to extend through the front and middle portions of the outer mast middle beam bracket 48 along the width direction of truck. Bolt holes 41E and 41F are formed in the vertically middle portions of the front and rear flanges 41B and 41C along the same direction as the bolt holes 48A, 48B. A bolt B4 is screwed into the bolt hole 41E through the bolt hole 48A, and a bolt B5 is screwed into the bolt hole 41F through the bolt hole 48B so that the outer mast middle beam bracket 48 is fixed to the outer mast rail 41.

A bolt hole 48C is formed in the rear portion of the outer mast middle beam bracket 48 along the longitudinal direction of the truck. An elongated hole 44A is formed so as to extend through the end portion of the outer mast middle beam 44 and functions as an outer mast rail width adjusting means of the present invention for adjusting the width between the outer mast rails 41 and 42. The elongated hole 44A is formed such that the dimension thereof as measured in the vertical direction is larger than that in the lateral direction. Namely, the dimension of elongated hole 44A in the direction perpendicular to the plane of FIG. 7 is larger than that in the vertical direction of FIG. 7. The dimension of the elongated hole 44A in the vertical direction is substantially the same as the diameter of the bolt hole 48C. A bolt B6 is screwed through the elongated hole 44A and into the bolt hole 48C that is formed in the outer mast middle beam 48 so that the outer mast middle beam 44 is fixed to the outer mast middle beam bracket 48. Thus, the outer mast middle beam 44 is connected to the outer mast rail 41 via the outer mast middle beam bracket 48. Furthermore, the outer mast rail 42 is similarly connected to the outer mast middle beam 44 via the outer mast middle beam bracket 49 by means of bolt connection. Also, the outer mast top beam 43 is similarly connected to the outer mast rails 41 and 42 via the outer mast top beam brackets 46 and 47 by means of bolt connection. A first bolt connection portion of the present invention corresponds to the end portion of the outer mast middle beam 44.

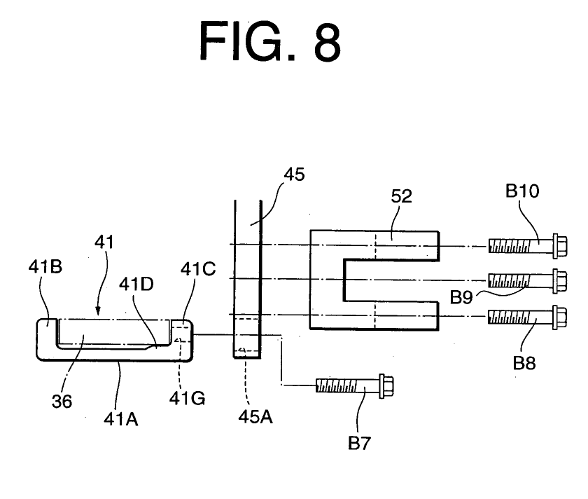

Referring to FIG. 8, a bolt hole 41G is formed in the lower portion of the rear flange 41C of the outer rail 41 so as to extend along the longitudinal direction of the truck. An elongated hole 45A is formed in the end portion of the outer bottom beam 45 in such a way that the dimension thereof as measured in the vertical direction is larger than that in the lateral direction. Namely, the dimension of the elongated hole 45A in the direction perpendicular to the plane of FIG. 8 is larger than that in the vertical direction of FIG. 8. The dimension of the elongated hole 45A as measured in the vertical direction is substantially the same as the diameter of the bolt hole 41G. A bolt B7 is screwed through the elongated hole 45A and into the bolt hole 41G in the outer mast rail 41 so that the outer mast bottom beam 45 is bolted to the outer mast rail 41. Also, the outer mast rail 42 is bolted to the outer mast bottom beam 45 in the similar manner. Meanwhile, the chain anchor plate 52 is connected to the outer mast bottom beam 45 by bolts B8 through B10.

Referring back to FIG. 6, a pair of roller pins (not shown) is provided protruding inward from the top portions of the outer mast rails 41, 42, and a pair of upper mast rollers 55, 55 is press-fitted onto the roller pins for rotation on the roller pins. As the lower mast rollers 36 roll along the outer mast rails 41 and 42, the upper mast rollers 55 roll along the inner mast rails 31 and 32.

In the mast structure of the present invention as described above, the inner mast rails 31, 32 are connected to the inner mast beams 33, 34 by means of bolt connection thereby to form the inner mast 3. The outer mast rails 41 and 42 are similarly connected to the outer mast beams 43 and 44 via the outer mast beam brackets 46, 47, 48 and 49 by means of bolt connection, and the outer mast rails 41 and 42 are directly connected to the outer mast beam 45 by means of bolt connection. Since the inner mast 3 and the outer mast 4 are thus formed by connecting component parts by means of bolt connection, manufacturing of the inner mast 3 and the outer mast 4 can dispense with welding. Therefore, dimensional accuracy of the inner and outer masts is improved over the counterparts formed by welding. While the inner mast bottom beam 34 is directly connected to the inner mast rail 31, it is also connected to the inner mast rail 31 via the seat 39 by means of bolt connection. Thus, the bolt connection between the inner mast rail 31 and the inner mast bottom beam 34 is strengthened.

The mast assembly 1 of the first preferred embodiment is not manufactured in such a way that, the inner mast 3 and the outer mast 4 are formed first, and then these masts are assembled to each other, but the beams and rails of the inner mast and the outer mast are assembled together thereby to manufacture the mast assembly 1. A large-size jig or fixture is unnecessary for manufacturing of the mast assembly, thus simplifying and hence facilitating the manufacturing of the mast assembly. As is well known in the art, it is necessary to eliminate looseness that is generated in the mast assembly 1 in the lateral direction when the mast assembly 1 is manufactured. In the first preferred embodiment, the elongated holes 34A and 34B are formed in the inner mast bottom beam 34, and the elongated holes 44A and 45A are formed in the outer mast middle beam 44 and the outer mast bottom beam 45, respectively. The bolts are screwed through the elongated holes 34A, 34B, 44A and 45A and into the bolts holes 31E, 39A, 48C and 41G formed in the inner mast rail 31, the seat 39, the outer mast middle beam bracket 48 and the outer mast rail 41. Changing the positions of the bolts in the elongated holes 34A, 34B, 44A and 45A, the width between the inner mast rails 31 and 32 as well as the width between the outer mast rails 41 and 42 are adjusted. Therefore, the looseness of the mast assembly 1 in the lateral direction is easily eliminated. Additionally, the adjustment which does not require shim or similar adjusting means can be accomplished with ease.

Now, the manufacturing procedure for the mast assembly 1 according to the present invention will be described. FIG. 9 is an exploded top view illustrating processes of assembling the mast assembly. In manufacturing the mast assembly 1, the lift bracket 2 is made by welding in advance. The lift roller 27 is fitted over the roller pin 25 formed in the backrest 21 of the lift bracket 2. The inner mast rail 31 as a part of the inner mast 3 is placed on the outside, or the left side in FIG. 9, of the lift bracket 2. The inner mast rail 31 is then moved inward, or the right side in FIG. 9, of the lift bracket 2 until the shoulder 31D of the inner mast rail 31 is brought into contact with the lift roller 27. Subsequently, the inner mast top beam 33 is placed on the rear side of the inner mast rail 31. An elongated hole 33A is formed in the end portion of the inner mast top beam 33 similarly to the elongated hole 34A in the inner mast bottom beam 34 as shown in FIG. 5. Also, the bolt hole 31F is formed in the top portion of the inner mast rail 31. With the inner top beam 33 placed on the rear side of the inner mast rail 31, the bolt B11 is inserted through the elongated hole 33A and screwed into the threaded bolt hole 31F. Thus, the inner mast 31 is connected to the inner mast top beam 33. At this time, the position of the bolt 11 is fine adjusted in the elongated hole 33A so that the inner mast rail 31 is appropriately positioned with respect to the lift roller 27. Thus, the looseness of the inner mast 3 is eliminated. Further, the lower roller 36 is fitted over the roller pin 35 formed in inner mast rail 31.

The inner mast top beam 33 is connected to the inner mast rail 32 as shown in FIG. 2, and the inner mast bottom beam 34 is connected to the inner mast rails 31, 32 in the manner similar to the above. At this time, the looseness of the inner mast 3 is similarly eliminated as described above. The lower mast roller 36 is fitted over the roller pin 35 of the inner mast rail 32. Thus, the inner mast 3 is completed.

After the inner mast 3 has been completed, the outer mast rail 41 is placed on the outside of the inner mast 3 or the left side in FIG. 9. Then, the outer mast rail 41 is moved inward, or the right side in FIG. 9, of the inner mast 3 until the shoulder 41D of the outer mast rail 41 is brought into contact with the lower mast roller 36. The upper mast roller 55 (FIG. 6) is previously connected to the top portion of the outer mast rail 41. Moving the outer mast rail 41, the shoulder 41D of the outer mast rail 41 is made in contact with the lower mast roller 31, where the upper mast roller 55 is also made in contact with the outer shoulder 31H formed on the outside of the inner mast rail 31. Thus, the upper mast roller 55 is movable or rollable relative to the outer flange 31G of the inner mast rail 31.

Subsequently, the outer mast top beam bracket 46 is placed on the outside, or the left side of FIG. 9, of the outer mast rail 41. In the outer mast rail 41, bolt holes 41H and 411 are formed in the top portions of the front and rear flanges 41B and 41C, respectively, along the lateral direction, and bolt holes 46A and 46B are formed in the outer mast top beam bracket 46 at positions corresponding to the bolt holes 41H and 411, respectively. A bolt B12 is screwed into the bolt hole 41H through the bolt hole 46A, and a bolt B13 is screwed into the bolt hole 411 through the bolt hole 46B, respectively, so that the outer mast top beam bracket 46 is fixed to the outer mast rail 41.

Then, the outer mast top beam 43 is placed on the rear side to the outer mast rail 43. An elongated hole 43A is formed in the end portion of the outer mast top beam 43 in a manner similar to the elongated hole 44A formed in the outer mast middle beam 44 as shown in FIG. 7. Also, a bolt hole 46C is formed in the rear portion of the outer mast top beam bracket 46. With the outer mast top beam 43 placed on the rear side of the outer mast rail 41, a bolt B14 is inserted through the elongated hole 43A and screwed into the bolt hole 46C. Thus, the outer mast rail 41 is connected to the outer mast top beam 43 via the outer mast top beam bracket 46. At this time, the position of the bolt B14 is fine adjusted in the elongated hole 43A so that the outer mast rail 41 is appropriately positioned with respect to the upper mast roller 55. In this manner, the looseness of the outer mast 4 is eliminated.

Then, the outer mast top beam 43 is connected via the outer mast top beam bracket 47 to the outer mast rail 42 as shown in FIG. 2. The outer mast middle beam 44 is connected to the outer mast rails 41 and 42 via the outer mast middle beam brackets 48 and 49, respectively, by means of bolt connection. The outer mast bottom beam 45 is connected to the outer mast rails 41 and 42 by means of bolt connection. Finally, the chain anchor plates 50 and 51 are connected to the outer mast top beam 43. Thus, the outer mast 4 is completed and, therefore, the mast assembly 1 is completed.

According to the above-described method of manufacturing the mast assembly 1 of the forklift truck C in the first preferred embodiment, the mast assembly 1 is not manufactured in such a way that the inner mast 3 and the outer mast 4 are assembled individually and then these masts are assembled together, but the beams and rails of the inner mast and the outer mast are assembled together thereby to manufacture the mast assembly 1. Therefore, a large-size jig or fixture is unnecessary for manufacturing of the mast assembly, thus simplifying and hence facilitating the manufacturing of the mast assembly. Furthermore, according to the mast assembly manufacturing method of the invention, parts control or management is conducted with respect to small-size parts such as outer mast rails and outer mast beams, not with respect to large-size parts such as inner masts and outer masts. Thus, the number of the part reference numbers is reduced, and the cost for parts management is reduced, accordingly.

Now, a second preferred embodiment according to the present invention will be described. The second preferred embodiment differs from the first preferred embodiment in the form of means for adjusting the inner mast rail width and the outer mast rail width.

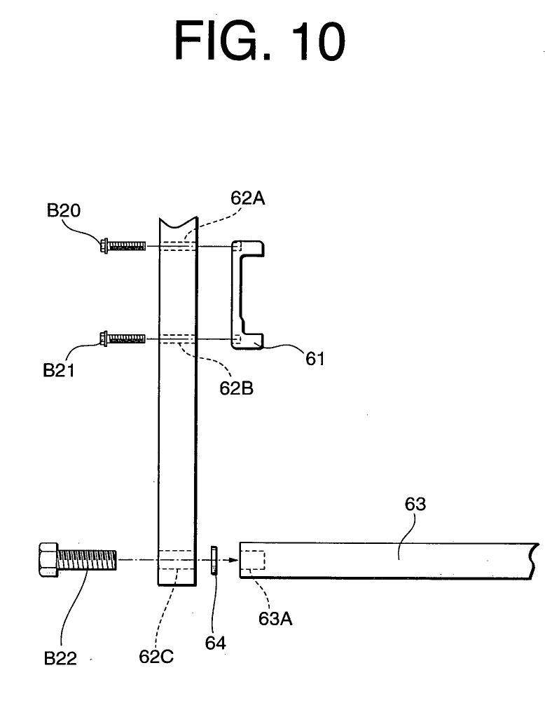

FIG. 10 is an enlarged top plan view of the connection between the outer mast rail and the outer mast beam of the outer mast in the mast assembly according to the second preferred embodiment. It is noted that the upper and lower sides of FIG. 10 correspond to the front and rear sides of the mast assembly, respectively. As shown in FIG. 10, an outer mast rail 61 of the mast assembly according to the second preferred embodiment is fixed to an outer mast beam bracket 62 by bolts B20 and B21. Bolt holes 62A and 62B are formed through the outer mast beam bracket 62 for receiving therethrough the bolts B20 and B21, respectively. An outer mast beam 63 is fixed to the rear portion of the outer mast beam bracket 62 by a bolt B22 with a spacer 64 interposed between the outer mast beam bracket 62 and the outer mast beam 63. For this purpose, a bolt hole 62C is formed through the outer mast beam bracket 62 for receiving therethrough the bolt B22, and a bolt hole 63A is formed in the outer mast beam 63 for screwing the bolt B22 thereinto. A through hole is formed in the spacer 64 for inserting therethrough the bolt B22. Furthermore, spacers are respectively provided at other connections between another outer mast beam and another outer mast bracket and between the inner mast beam and an inner mast bracket.

In the mast assembly constructed as described above according to the second preferred embodiment, the spacers 64 are interposed between the outer mast beam 63 and the outer mast beam bracket 62 connected to the outer mast rail 61. A plurality of the spacers 64 having different widths is prepared so that the width between the outer mast beams is adjusted easily by selecting spacers of appropriate thicknesses. The spacer is also interposed between the inner mast rail and the inner mast beam for the same purpose of width adjustment.

Although the first and second preferred embodiments according to the present invention have been described, the present invention is not limited to the above-described first and second preferred embodiments. Though the elongated holes are utilized as the mast rail width adjusting means in the first preferred embodiment, such holes may be substituted by holes having a diameter larger than the diameter of its associated threaded hole, but small enough to make possible fastening by bolt.

Therefore, the present examples and embodiments are to be considered as illustrative and not restrictive and the invention is not to be limited to the details given herein but may be modified within the scope of the appended claims.

What is claimed is:

1. A mast assembly for a forklift truck comprising:
an outer mast including a pair of substantially vertical outer mast rails and a substantially horizontal first outer mast beam that is connected to the outer mast rails by means of bolt connection;
an inner mast vertically movably connected to the outer mast via mast rollers, the inner mast including a pair of substantially vertical inner mast rails and a substantially horizontal inner mast beam that is connected to the inner mast rails by means of bolt connection; and
a lift bracket connected to the inner mast via lift rollers.

2. The mast assembly according to claim 1, wherein an outer mast rail width adjusting means is formed at each of first bolt connection portions where the first outer mast beam is connected to the outer mast rails for adjusting a width between the outer mast rails.

3. The mast assembly according to claim 2, wherein the outer mast rail width adjusting means is an elongated hole.

4. The mast assembly according to claim 3, wherein the elongated hole has a vertical dimension and a lateral dimension that is larger than the vertical dimension.

5. The mast assembly according to claim 1, wherein the first outer mast beam is respectively connected to the outer mast rails via outer mast beam brackets by means of bolt connection.

6. The mast assembly according to claim 5, wherein a spacer is interposed between the first outer mast beam and the outer mast beam bracket for adjusting the width between the outer mast rails.

7. The mast assembly according to claim 1, wherein the outer mast includes a substantially horizontal second outer mast beam that is directly connected to the outer mast rails by means of bolt connection.

8. The mast assembly according to claim 1, wherein an inner mast rail width adjusting means is formed at each of second bolt connection portions where the inner mast beam is connected to the inner mast rails for adjusting a width between the inner mast rails.

9. The mast assembly according to claim 8, wherein the inner mast rail width adjusting means is an elongated hole.

10. The mast assembly according to claim 9, wherein the elongated hole has a vertical dimension and a lateral dimension that is larger than the vertical dimension.

11. The mast assembly according to claim 1, wherein a seat is provided at each of second bolt connection portions where the inner mast beam is connected to the inner mast rails.

12. A method of manufacturing a mast assembly for a forklift truck, the mast assembly including a lift bracket, an inner mast and an outer mast, the lift bracket having lift rollers, the inner mast having a pair of substantially vertical inner mast rails and a substantially horizontal inner mast beam, the outer mast having a pair of substantially vertical outer mast rails and a substantially horizontal outer mast beam, the method comprising the steps of:
placing a pair of the inner mast rails on both outsides of the lift bracket via the lift rollers, respectively;
connecting the inner mast beam to each of the inner mast rails by means of bolt connection so as to form the inner mast;
placing a pair of the outer mast rails on outsides of the inner mast rails via mast rollers, respectively; and
connecting the outer mast beam to each of the outer mast rails by means of bolt connection so as to form the outer mast.
